(19) United States
(12) Patent Application Publication
(10) Pub. No.: US 2005/0194557 A1
(43) Pub. Date: Sep. 8, 2005

(54) Flatface Fluid Fluid Sampling Valve

(75) Inventor: Bernard E. Hall, London (CA)

Correspondence Address: CHECKFLUID INC., 4500 BLAKLE ROAD, UNIT #102, LONDON, N6L 1G5, CA

(73) Assignee: CHECKFLUID INC., London (CA)

(21) Appl. No.: 10/906,766

(22) Filed: Mar. 4, 2005

Related U.S. Application Data
(60) Provisional application No. 60/521,181, filed on Mar. 4, 2004.

(51) Int. Cl. F16L 29/00

(52) U.S. Cl. 251/149.4

(57) ABSTRACT

The invention is comprised of both a male and female member that join to form a compact flatface connection for fluid transfer typically for low pressure fluid sampling for a wide range of fluid viscosities. The invention relates to the method of achieving several features in one design; high flow, small size, and a flat face valve on the male member. The present invention relates to a fluid transfer connection, and method of producing said connection. More specifically, the present invention relates to a novel combination of features: high flow, and small size for use in a low pressurized fluid or gas connection, where the female member is secured onto the male member and sealed with a flat face type seal.

### BACKGROUND OF INVENTION

The present invention relates to an improved connection, primarily for the low pressure or vacuum transfer of fluids or gases. Initially beginning connection, the spacer on the female member is energized to independently seal the perimeter of the fluid passage at the face of the flatface valve. As connection continues, the stem on the female member activates the valve on the male member while keeping the spacer sealing at the face of the valve.

Typically such connections have either a male member with a threaded portion for dynamic connecting, or a groove or protrusion for quick connecting, and a female member with a groove for capturing the sealing element and a matching portion either for dynamic or quick connecting. Commonly, current designs are of considerable size in order to maintain high flow, such as the ISO 15171-1 profiled connections.

Currently the male members used are either large in nature, small with a low cross sectional area for media transfer, have no valve or have recessed valves likely to retain and allow sediment to pass into the fluid. Current design examples include the connections shown in both ISO 15171-1 and ISO 15171-2. The female of ISO 15171-1 seals externally on the male, has higher flow but has a larger female member and ISO 15171-2 in which the male seals internally on the female probe, allowing a smaller female member but also low flow characteristics. It is incidental that the first uses a quick attach method of connection, and the latter uses a threaded dynamic connection. In summary the connection of ISO 15171-1 having both a large sized male and female member, maintains a larger cross sectional area for flow, while the ISO 15171-2 connection has a smaller female member and smaller cross sectional area for lower flow.

### BRIEF DESCRIPTION OF DRAWINGS

FIG. 1 is a cutaway view of the male and female components.

FIG. 2 is a cutaway view of the assembly showing the valve open position and flat face sealing.

FIG. 3 is a principal view of the male member showing the flat face valve surface.

FIG. 4 is a principal view of the female member showing the sealing spacer and activating probe.

FIG. 5 is an exploded view of the female member.

FIG. 6 is an exploded view the male member.

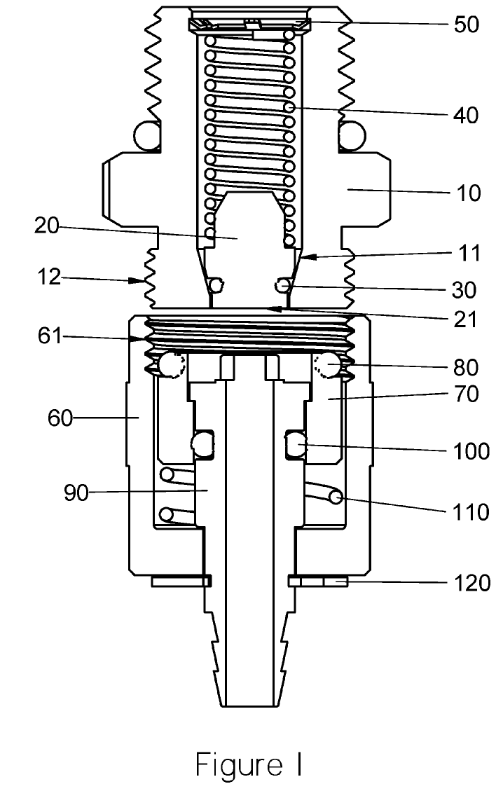

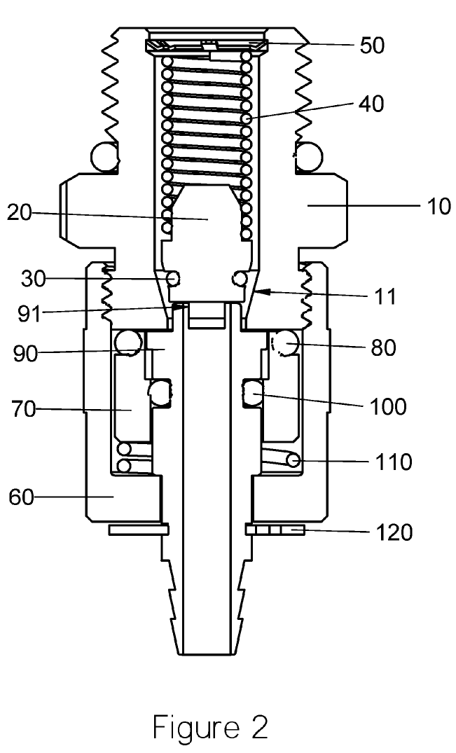

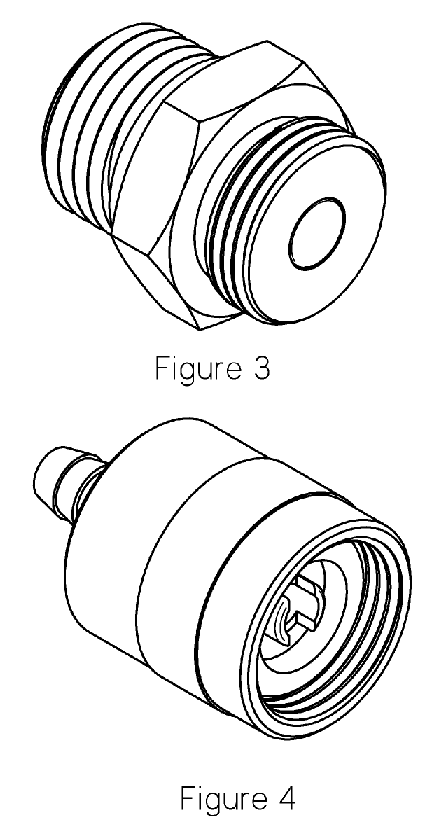

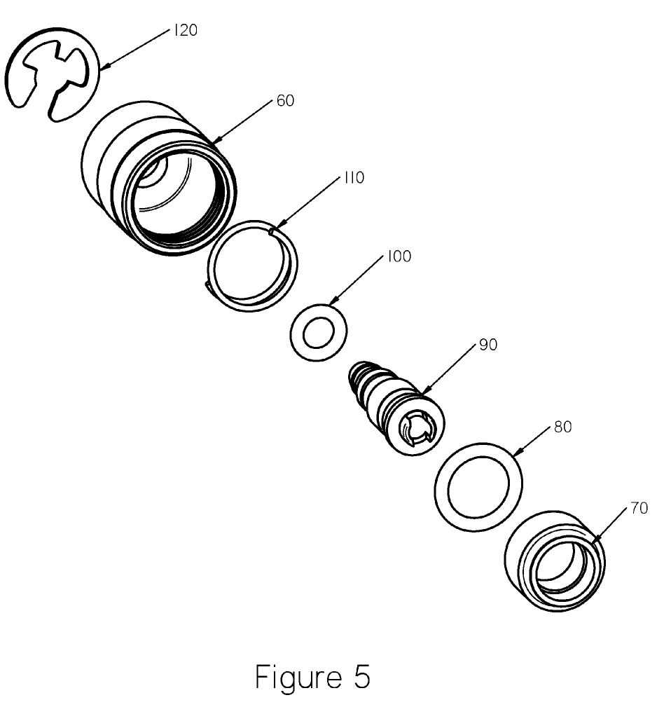

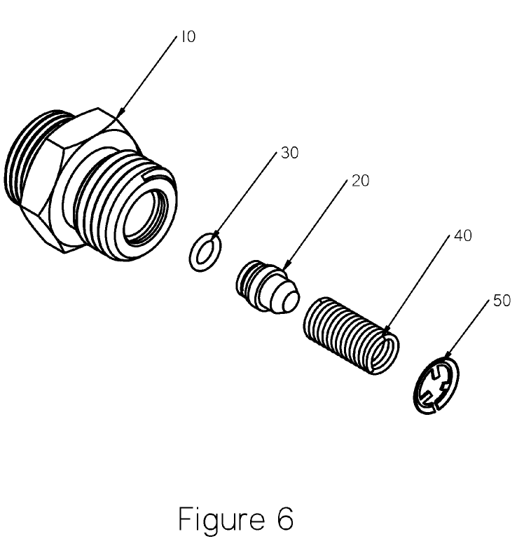

### DETAILED DESCRIPTION

According to the present invention the male member 10 of the connection is designed with the standard external diameter for the inner valve component, to mate with the female half 60, according to the flow requirements of ISO 15171-1. The internal valve 20 arrangement is configured with a short conical section on both the inner bore of the valve body 11, and the outer profile of the valve component 20. A recess is positioned along the conical section of the valve component 20 to accept a valve sealing member 30. The angle of the conical section, both before and after the recess for the valve sealing member provides protection of the valve sealing member against pressure spikes while the valve remains closed, as the metal-metal seat will absorb the majority of the pressure. Having the valve component 20 and valve sealing member 30, sealing against a conical section, also allows for the valve to be opened with less movement of the valve component. The valve component is normally held against the conical seat in the valve body by means of a spring 40. When activated, the valve component 20 moves away from the conical seat 10 in the valve body, and the differences in diameter between the front of the valve component, and the larger hole diameter in the valve body, allows for a larger cross-sectional area for transfer of the fluid or gas. Externally the male member 10 is provided with a threaded portion 12 for interaction with the female member 61. The threaded connection keeps the length of both the male and female members to a minimum.

The female member of the present invention is designed with a threaded swivel nut 60 for interaction with the male member 10, a valve spacer 70 for co-axial movement and sealing member retention 80, a stem 90 that actuates the male member 20, a spring 110 to energize the valve spacer 70, and two sealing elements 80, 100 to prevent leakage of the fluid or gas. The threaded connection is short and allows for less length in the male member, than more common quick connects. The swivel nut 60 is retained on the stem 90 with a retaining clip 120 and allows engagement or disengagement without turning the valve spacer 70 and stem 90. A captured sealing element 80 positioned in a recess in the valve spacer 70 seals against the male member 10 in a way that permits the male member 70 to utilize a flat face design. Having the sealing element 80 on the valve spacer 70 and the spring energizer 110, allows for the sealing to be removed from the stem 90, which in turn allows for the stem to be slotted 91 to allow for a more significant cross-sectional area for flow, as well as allowing for less valve component travel in the male member, thus shortening the length of both male and female members and reducing purge sample volumes.

1. A method of fluid connection for a male and female member comprising:
A female member having an elastomeric face seal on a spacer that is energized, co-axially moveable, separate from the valve stem, that seals on the flat face of the male member before valve activation and allows greater flow through the valve stem. A male member having a conical seat, an energized valve component with a retained sealing element, and a flat external face, allowing for a larger flow passage and a reduction in overall length for valve activation.

2. A connection method as set forth in claim 1, wherein both the male and female members also have a threaded section for mechanical interaction to create the connection, allowing for reduction of the overall size of the male member.

3. A connection method as set forth in claim 1 or 2, wherein the conical seat is replaced with a flat seat, to create either an internal face seal, or a barrel seal, thus providing a more secure sealing method, with only a slight increase of overall size of the male member.

4. A connection method as set forth in claim 1, wherein the male and female members have a ball groove and locking ball mechanism to create the connection, allowing for a reduction in the speed of connection.
